(19) United States
(12) Patent Application Publication
(10) Pub. No.: US 2009/0222832 A1
(43) Pub. Date: Sep. 3, 2009

(54) SYSTEM AND METHOD OF ENABLING RESOURCES WITHIN AN INFORMATION HANDLING SYSTEM

(75) Inventor: Andrew T. Sultenfuss, Leander, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/039,872

(22) Filed: Feb. 29, 2008

(51) Int. Cl. G06F 9/46

(52) U.S. Cl. 718/104

(57) ABSTRACT

A system and method of enabling resources within an information handling system is disclosed. In one form, an information handling system can include an event detection module operable to detect user initiated events and non-user initiated events. The information handling system can also include a resource allocation module coupled to the event detection module. In one form, the resource allocation module can be operable to map a first detected event to a first operating state of a first processing system. The information processing system can also include a second processing system responsive to the resource allocation module and operable to access a shared resource of the first processing system. The resource allocation module can be configured to initiate an outputting of information intended to be output by the second processing system using a shared resource of the first processing system.

### FIELD OF THE DISCLOSURE

This disclosure relates generally to information handling systems, and more particularly to a system and method of enabling resources within an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can be configured to use a variety of hardware and software components that can be configured to process, store, and communicate information and can include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 illustrates a functional block diagram of an information handling system operable including allocated resources according to one aspect of the disclosure;

FIG. 3 illustrates a flow diagram of a method of accessing resources within an information handling system according to one aspect of the disclosure;

FIG. 4 illustrates a functional block diagram of an information handling system including modifiable operating states to output germane and non-germane reduced resources to output non-germane content using local resources according to one aspect of the disclosure;

FIG. 5 illustrates a functional block diagram of an information handling system employing reduced resources to output non-germane content using local resources according to one aspect of the disclosure;

FIG. 6 illustrates a functional block diagram of an information handling system employing allocating and de-allocating resources output germane content using local resources according to one aspect of the disclosure; and

FIG. 7 illustrates a functional block diagram of a resource allocation module allocating local resources of an information handling system to output non-germane content according to one aspect of the disclosure.

The use of the same reference symbols in different drawings indicates similar or identical items.

### DETAILED DESCRIPTION OF DRAWINGS

The following description in combination with the figures is provided to assist in understanding the teachings disclosed herein. The following discussion will focuses on specific implementations and embodiments. This focus is provided to assist in describing the teachings and should not be interpreted as a limitation on the scope or applicability of the teachings. However, other teachings can certainly be used in this application. The teachings can also be used in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

Portions of an information handling system, when referred to as a “device,” a “module,” or the like, can be configured as hardware, software (which can include firmware), or any combination thereof. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be software, including firmware embedded at a device, such as a Pentium class or PowerPC™ brand processor, or other such device, or software capable of operating a relevant environment of the information handling system. The device could also be a combination of any of the foregoing examples of hardware or software. Note that an information handling system can include an integrated circuit or a board-level product having portions thereof that can also be any combination of hardware and software.

Devices or programs that are in communication with one another need not be in continuous communication with each other unless expressly specified otherwise. In addition, devices or programs that are in communication with one another may communicate directly or indirectly through one or more intermediaries.

Embodiments discussed below describe, in part, distributed computing solutions that manage all or part of a communicative interaction between network elements. In this context, a communicative interaction may be intending to send information, sending information, requesting information, receiving information, receiving a request for information, or any combination thereof. As such, a communicative interaction could be unidirectional, bidirectional, multi-directional, or any combination thereof. In some circumstances, a communicative interaction could be relatively complex and involve two or more network elements. For example, a communicative interaction may be “a conversation” or series of related communications between a client and a server—each network element sending and receiving information to and from the other. The communicative interaction between the network elements is not necessarily limited to only one specific form. A network element may be a node, a piece of hardware, software, firmware, middleware, another component of a computing system, or any combination thereof.

In the description below, a flow charted technique may be described in a series of sequential actions. Unless expressly stated to the contrary, the sequence of the actions and the party performing the actions may be freely changed without departing from the scope of the teachings. Actions may be added, deleted, or altered in several ways. Similarly, the actions may be re-ordered or looped. Further, although processes, methods, algorithms or the like may be described in a sequential order, such processes, methods, algorithms, or any combination thereof may be operable to be performed in alternative orders. Further, some actions within a process, method, or algorithm may be performed simultaneously during at least a point in time (e.g., actions performed in parallel), can also be performed in whole, in part, or any combination thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single device is described herein, more than one device may be used in place of a single device. Similarly, where more than one device is described herein, a single device may be substituted for that one device.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the computing, electronics, and software arts.

An information handling system and method of using it are described below. An exemplary, non-limiting system description is described before addressing methods of using it. Some of the functionality of modules within the system is described with the system. The utility of the system and its modules will become more apparent with the description of the methods that follow the description of the system and modules.

According to an aspect of the disclosure, an information handling system can include an event detection module operable to detect user-initiated events and non-user initiated events. The information handling system can also include a resource allocation module coupled to the event detection module. In one form, the resource allocation module can be operable to map a first detected event to a first operating state of a first processing system. The information processing system can also include a second processing system responsive to the resource allocation module and operable to access a shared resource of the first processing system. The resource allocation module can be configured to initiate an outputting of information intended to be output by the second processing system using a shared resource of the first processing system.

According to another aspect of the disclosure, a method of enabling resources within an information handling system is disclosed. The method can include detecting an event operable to initiate access to a first set of resources of a first processing system. The method can also include identifying a first profile of the first processing system. In one form, the first profile can include a plurality of resource allocation entries of the first information handling system accessible to a second processing system. The method can also include enabling the first set of resources of the first processing system using the plurality of resource allocation entries, and accessing the first set of resources using the second processing system.

According to a further aspect of the disclosure, an information handling system can include a first processing system having a first host processor operable to process information using a first set of available resources. In one form, the first set of available resources can include a shared display resource including a memory device storing a display resolution value, and a shared input device configured to receive inputs via a shared operating environment and a non-shared operating environment. The information handling system can also include a second processing system having a second host processor operable to process information to output via the first processing system, and a video translation module operable to access the display resolution value to format the information to output using the shared display. The information handling system can further includes an event detection module configured to detect user activated events and non-user activated events. In one form, the event detection module can be further configured to initiate access to the first processing system using a portion of the second processing system. The information handling system can further include a resource allocation module operable to determine available resources of the first processing system and the second processing system.

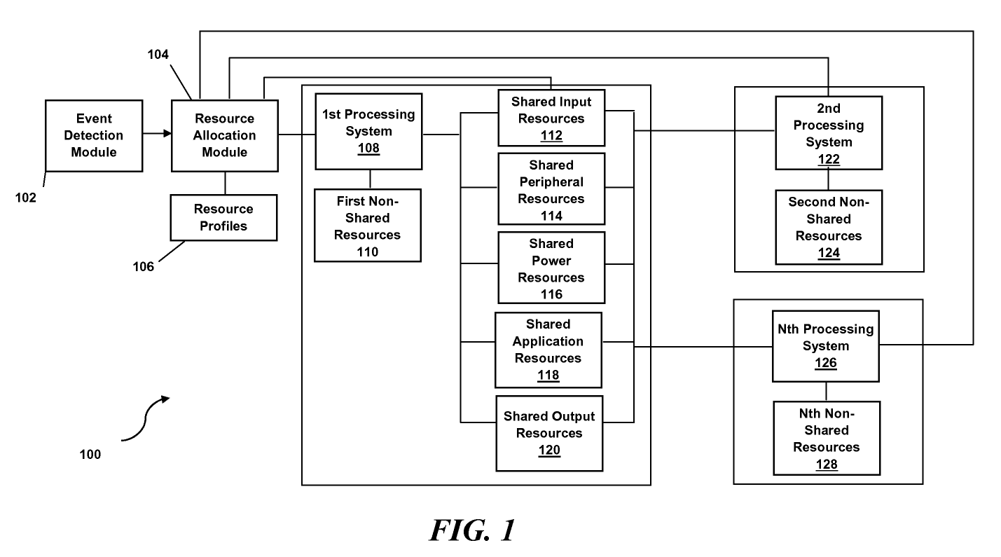

FIG. 1 illustrates a block diagram of an exemplary embodiment of an information handling system, generally designated at 100. In one form, the information handling system 100 can be a computer system such as a desktop computer, notebook computer, server or various other types of information handling systems. As shown in FIG. 1, the information handling system 100 can include an event detection module 102 operable to detect user activated and non-user activated events. The event detection module 102 can be coupled to a resource allocation module 104 having access to one or more resource profiles 106. The information handling system 100 can also include a first processing system 108 coupled to first non-shared resources 110 of the first processing system 108. In one form, the first processing system 108 can include a host chipset, processor, memory, communication buses, peripheral devices, applications, a Basic Input/Output System (BIOS), or any combinations thereof (not illustrated). The first processing system 108 can also include shared resources including shared input resources 112, shared peripheral resources 114, shared power resources 116, shared application resources 118, shared output resources 120, or any combination thereof. The first processing system 108 can be coupled to the resource allocation module 104 operable to allocate shared resources to be used in response to an event detected by the event detection module 102, and one or more associated resource profiles 106. In one form, the shared resources 112, 114, 116, 118, 120, can be configured as a part of the first processing system 108 and accessible by one or more processing systems. In other forms, one or more of the shared resources can be provided external to the first processing system 104.

According to a further aspect, the information handling system 100 can also include a second processing system 122 including second non-shared resources 124. The second processing system 122 can be coupled to one or more of the shared resources 112, 114, 116, 118, 120 of the first processing system 108. The second processing system 122 can further be coupled to the resource allocation module 104 operable to allocate resources to be used by the second processing system 122. Additionally, the resource allocation module 104 can further be coupled to an n^{th} processing system 126 operable to be coupled to one or more of the shared resources 112, 114, 116, 118, 120 of the first processing system 108. The n^{th} processing system 126 can further include n^{th} non-shared resources 128.

During operation, the event detection module 102 can detect a user initiated event, a non-user initiated event, or any combination thereof. For example, a user initiated event can include a user activating a key, button, or other type of hardware, software, or user selectable interface, or combinations thereof, that can generate a user activated event. For example, a user can select a button to access a messaging application of the information handling system 100. As such, the event detection module 102 can detect a request to access the messaging application and couple an event request to the resource allocation module 104.

According to another aspect, the event detection module 102 can detect a non-user initiated event. For example, the information handling system 100 can include a communication module (not illustrated) operable to receive communication signals via a wireless communication, terrestrial or wire-line communication, or any combination thereof. The information handling system 100 can detect the non-user initiated event, and can couple an input identifying detection of the event to the resource allocation module 104. The resource allocation module 104 can identify a resource profile 106 using the detected event, and initiate activation of resources to process the non-user initiated event. For example, the resource profiles 106 can include a listing of desired resources of the first processing system 108, the second processing system 122, the nth processing system 126, or any combination thereof. The resource allocation module 104 can then initiate activation of resources based on the resource profile using the detected event, and resources available to process the event.

In one form, the information handling system 100 can detect a non-user initiated event communicated to an electronic device other than the information handling system 100. For example, the event detection module 102 can be configured to detect a message formatted to be received by a smart phone device, Blackberry device, or any type of electronic device configured to receive messages. For example, the information handling system 100 can include a communication module (not illustrated) operable to detect wireless messages communicated via any network operable to communicate messages. For example, a wireless messaging network such as an SMS network, Blackberry enabled network, or any other type of messaging enabled wireless or wireline network. According to an aspect, the event detection module 102 can couple a detected input to the resource allocation module 104 indicating that a Blackberry formatted (or other format) message has been detected. As such, the resource allocation module 104 can access the resource profiles 106 and determine a resource profile of the event and initiate allocation of resources to process the Blackberry message.

In an exemplary form, the information handling system 100 can be operating in a low-power operating state that can include sufficient resources to detect a wireless signal. As such, the resource allocation module 104 can determine the current operating state of the information handling system 100, and initiate enabling resources, such as a second processing system 122, shared input resources 112, shared power resources 116, shared application sources 118, shared output sources 120, or any combination thereof to process and output a response to the received wireless signal. As such, an operating environment to output a response to a message, such as a Blackberry message, can be enabled using a limited amount of resources without having to initialize additional resources of the information handling system 100. For example, a shared peripheral resource 114 such as a display can be accessed to output the message using the second processing system 122. Additionally, a keyboard or other input device of the first processing system 108 can be powered to enable a user to respond to the message. As such, a limited resource operating environment can be generated to allow for receipt and response to messages without having to power the entire information handling system 100. In the manner, a laptop or notebook system can be used to receive messages that may be intended for a Blackberry or other type of messaging device, thereby allowing a user to view messages using a larger display relative to the Blackberry device or smart phone device, and draft and respond to messages using a keyboard and display of a portable or notebook system and associated input devices as desired.

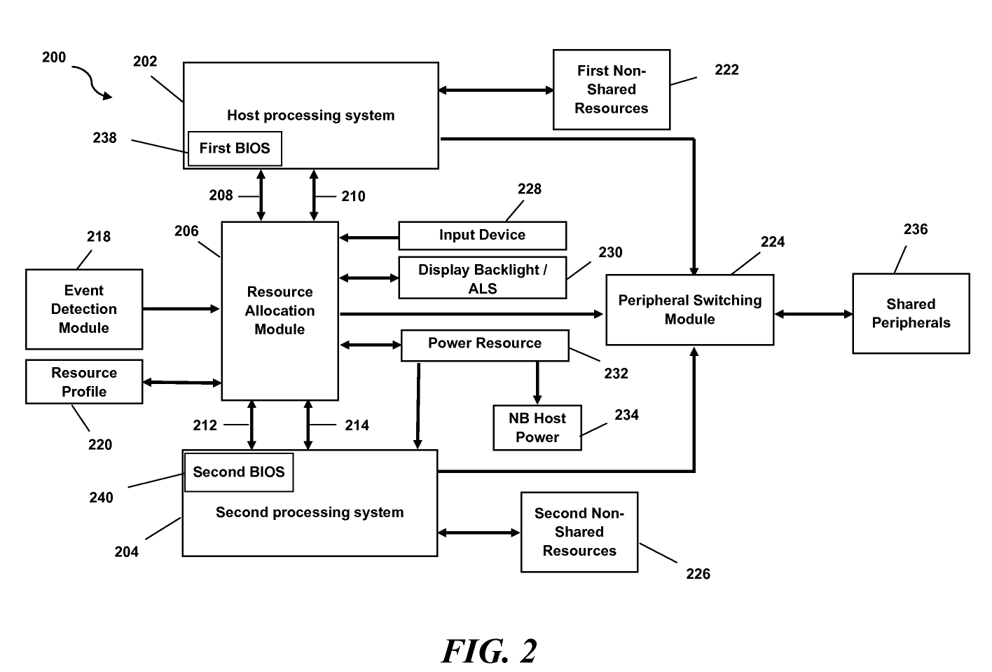

FIG. 2 illustrates a functional block diagram of an information handling system 200 operable including allocated resources according to one aspect of the disclosure. The information handling system can include a host processing system 202 that can include a host CPU, a host CPU chipset, memory, a host operating system. The host processing system 202 can also include a first BIOS 238 operable to enable resources accessible to the host processing system 202. The information handling system 200 can also include a second processing system, illustrated generally as second processing system 204, that can include an auxiliary CPU, a auxiliary CPU chipset, auxiliary memory, and an auxiliary operating system. The second processing system 204 also includes a second BIOS 240 operable to enable resources accessible to the second processing system 204. In one form, the second processing system 204 can include BIOS extensions or input that can be commonly used by the host processing system 202.

According to an aspect, the host processing system 202 and the second processing system 204 can be coupled to a resource allocation module 206. For example, the host processing system 202 can be coupled to the resource allocation module 206 using a first bus 208 and a second bus 210. In one form, the first bus 208 can include a low pin count (LPC) bus and the second bus can include a system management bus (SMBUS). Additionally, the second processing system 204 can be coupled to the resource allocation module 206 using a third bus 212 and a fourth bus 214. In one form the third bus 212 can include a PS2 bus, an RS232 bus, an SPI bus, or other types of buses. In another form, the fourth bus 214 can include an SMBUS, or other type of bus as desired.

The information handling system 200 can also include an event detection module 218 coupled to the resource allocation module 206 and a resource profile source 220 stored within a memory and accessible to the resource allocation module 206. The host processing system 202 can also be coupled to first non-shared resources 222 and a peripheral switching module 224. The second processing system 202 can be coupled to second non-shared resources 226 and the peripheral switching module 224. The resource allocation module 206 can also be coupled to an input device 228, such as a keyboard, pointing device, or combinations thereof. The resource allocation module 206 can also be coupled to a display 230 such as flat screen or flat panel display that can include a backlight and ambient light sensing (ALS) capabilities. The resource allocation module 206 can further be coupled to a power resource 232 operable to power the second processing system 204 and to output host processing power 234. The peripheral switching module 224 can further be coupled to one or more shared peripherals 236.

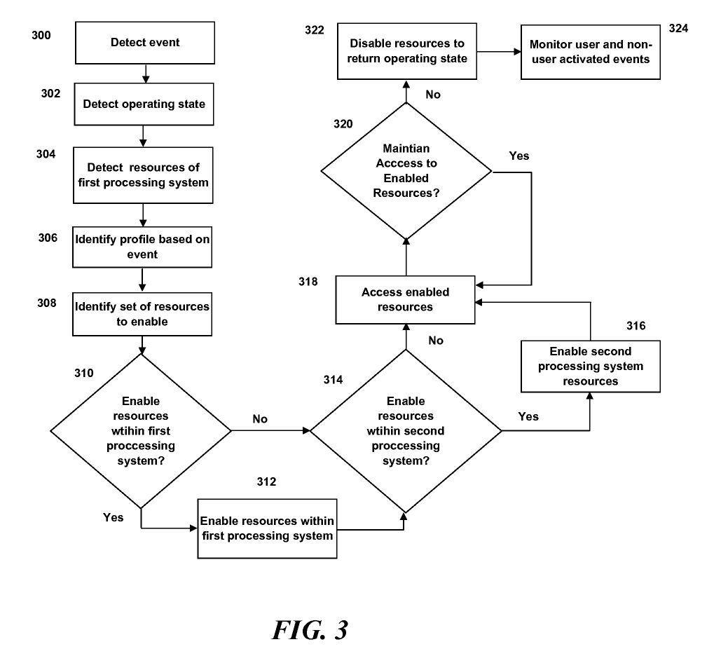

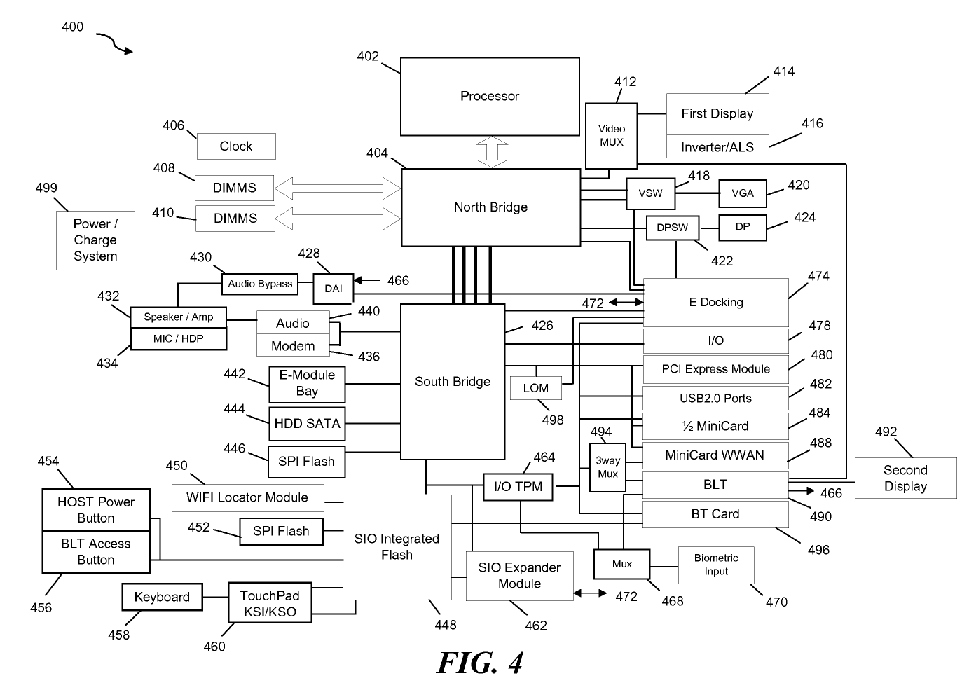

FIG. 3 illustrates a flow diagram of a method of accessing resources within an information handling system according to one aspect of the disclosure. FIG. 3 can be employed in whole, or in part, by the information handling system 100 depicted in FIG. 1, the information handling system 200 described in FIG. 2, information handling system 400 described below in FIG. 4, or any other type of system, controller, device, module, processor, or any combination thereof, operable to employ all, or portions of, the method of FIG. 3. Additionally, the method can be embodied in various types of encoded logic including software, firmware, hardware, or other forms of digital storage mediums, computer readable mediums, or logic, or any combination thereof, operable to provide all, or portions, of the method of FIG. 3.

The method begins generally at block 300 when an event is detected. For example, the event can include a user-activated event, a non-user activated event, or combinations thereof, that initiate altering an operating state of an information handling system. For example, an event can include a message, a communication, a button selection, or other form of input to alter an operating condition of an information handling system. The event can be detected to enable resources within an information handling system including multiple processing systems having hardware and software components that can be selectively enabled and shared between the processing systems to process an event and create an operating environment not currently being used by the information handling system. In some embodiments, it may be advantageous to only use portions of a processing system to enable an operating environment that may not be intended to be used on one of the processing systems or the information handling system. For example, a notebook or laptop computer system may not traditionally be used to create an operating environment of a handheld device such as a mobile communications device and the like. As such, limited resources of the information handling system including a first processing system can be accessed and used by a second processing system within the information handling system to create a desired operating environment, such as a mobile communication device operating environment. In this manner, an information handling system including a notebook or laptop computing system can generate a reduced resource operating environment in response to detected events.

Upon detecting an event, the method can proceed to block 302 and an operating state of an information handling system can be determined. For example, operating conditions can include various operating states of an information handling system including, but not limited to, a low-power state, standby, hibernate, off, on, or various other operating states. Upon detecting an operating state of the information handling system, the method can proceed to block 304 and the method can detect available resources of a first processing system within the information handling system. For example, a sleep mode can be detected and as such limited resources of a first processing system within the information handling system may be activated. For example, a communication module, a low-power communication bus, a low-power consumption processor or controller, etc. may be the only resources of the first processing system enabled. In one form, a BIOS of an information handling system can be accessed to determine which resources have been enabled. As such, upon detecting an operating state and enabled resources, the method can proceed to block 306 and a resource profile based on the detected event can be identified. For example, a resource profile can be stored within a memory device of the information handling system and can include a plurality of resource entries to enable processing the detected event.

Upon accessing the resource profile, the method can proceed to block 308 and identifies a set of resources to enable within a first processing system, a second processing system, an n^{th} processing system or any combination thereof. For example, a first set of resources of the first processing system can be used with a second set of resources of a second processing system to process the detected event or initiate an application. In another form, one or more devices or components within the first processing system or the second processing system can be powered to an active operating state. As such, a power resource can be coupled to one or more devices to enable or power one or more additional resources within the first processing system or the second processing system. In this manner, power need not be applied to all devices or components of each processing system and can be selectively activated as needed or desired using the resource profile.

Upon identifying resources to enable, the method can proceed to decision block 310, and determines if resources within the first processing system should be enabled. If resources should be enabled, the method can proceed to block 312 and specific resources within the first processing system can be enabled. For example, the first processing system can include an output device, such as a display, and an input device, such as a keyboard, that can be enabled in association with a specific event and resource profile. As such, the method can enable specific resources of the first processing system, and can proceed to decision block 314. If at block 310, resources within the first processing system do not need to be enabled, the method can proceed to decision block 314 and determines if resources within a second processing system should be enabled. For example, the second processing system can include a processor, communication module, software, or other resource that can be enabled and used with the enabled resources of the first processing system if desired. If at decision block 314, resources within a second processing system are to be enabled, the method can proceed to block 316, and enables resources within the second processing system. For example, the second processing system resources can be identified at block 308, and enabled at block 316 as desired.

Upon enabling specific resources, the method can then proceed to block 318, and the enabled resources of the first processing system and the second processing system, if desired, can be accessed and used in association with the detected event. Upon accessing the enabled resources, the method can then proceed to decision block 320, and determines if access to the resources should be maintained. If at decision block 320, access should be maintained, the method can proceed to block 318. If at decision block 320, access should not be maintained, the can proceed to block 322, and the enabled resources of the first processing system and the second processing system can be disabled as desired. For example, enabled resources can be disabled to return the information handling system to a previous or alternative operating state as desired. The method can then proceed to block 324 and monitors user and non-user activated events, and can repeat at block 300 upon detecting an event.

FIG. 4 illustrates a functional block diagram of an information handling system, illustrated generally at 400, configured to employ modifiable operating states to output data using reduced local resources according to one aspect of the disclosure. The information handling system 400 includes a processor 402, coupled to a north bridge 404. A clock 406 can output a timing signal to the processor 402 and other components of the information handling system 400. The north bridge 404 can be further coupled to a first dual in-line memory module (DIMM) 408 and a second DIMM 410. The north bridge 404 can also be coupled to a video multiplexer 412 operable to output video signals to be displayed within a display 414. The display 414 includes an inverter and automatic light sensor module 416. The north bridge 404 can be further coupled to a video switch module 418 and a video graphics array (VGA) port 420. A display port 424 can be coupled to a display port switch 422 operable to be coupled to the north bridge 404 and an E Dock module 474 that can expand resources of the system 400 to access a battery, media slice, I/O box, or various other resources.

The information handling system 400 also includes a south bridge 426 coupled to the north bridge 404. A DAI module 428 can receive an audio signal from an input source 466 from a BLT module 466. The DAI module 428 can also be coupled to an E docking source 474 and an audio bypass 430. The audio bypass 430 can be further coupled to a speaker and amplifier 432. The speaker and amplifier 432 can also be coupled to a microphone and head phone module 434. The south bridge 426 can also be coupled to a modem 436 such as an RJ-11 or POTS enabled modem, and an audio output module 440 operable to couple audio output signals using the south bridge 426.

The south bridge 426 can be coupled to the E module bay 442, a serial advanced technology attachment hard disk drive (SATA HDD) 444, and a first serial peripheral interface (SPI) flash memory 446. The south bridge 426 can also be coupled to a serial I/O (SIO) integrated flash module 448. The SIO integrated flash module 448 can be coupled to a wireless fidelity (WIFI) locator module 450 which can refer to any type of 802.11x or other short range wireless network, an second SPI flash module 452, a host power button 454, and a resource access button 456. A keyboard 458 can be couple to a touchpad and KSI/KSO module 460. The SIO expander module 462 can also be coupled to the SIO integrated flash 448 and can further be coupled to an I/O TPM module 464. The I/O trusted platform module (TPM) module 464 can be coupled to a biometric multiplexer 468 and a biometric input source 470 operable to input biometrics of a user.

The E-docking module 474 can also be coupled to the SIO expander module 448 via interface 472. The south bridge 426 can further be coupled to an I/O module 478, a PCI express module 480 via a peripheral computer interconnect (PCI) express bus. The south bridge 426 can further be coupled to USB 2.0 access ports 482 using a USB bus of the information handling system 400. A ½ Mini Card module 484 can also be coupled to the south bridge 426 using a PCI express bus. The information handling system 400 can also include a MiniCard wireless wide area network (WWAN) module 488 coupled to the south bridge 426.

The information handling system 400 further includes a BLT module 490 operable to be coupled to a second display 492 and configured to output a video signal to the video MUX 412 to output to the first display 414. The BLT module 490 can further be coupled to a three (3) way multiplexer 494. The three (3) way multiplexer 494 can multiplex USB signals of the Minicard WWAN 488, the BLT module 490, and the USB bus coupled to the south bridge 404. The south bridge 426 can further be coupled to a Bluetooth (BT) card 496 via the USB bus. The south bridge 426 can also be coupled to a local area network (LAN) on Motherboard (LOM) 498 via a PCI express bus of the information handling system 400. The LOM 498 can also be coupled to the PCI express module 480. The information handling system 400 also includes a power and charge system 499 operable to distribute power to each component of the information handling system 400.

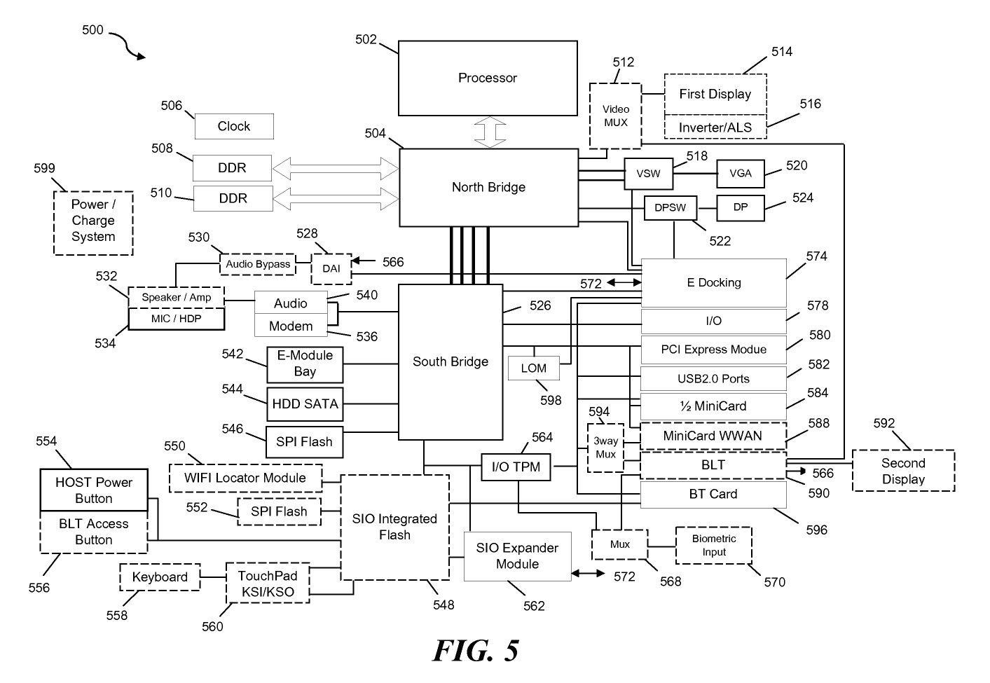

FIG. 5 illustrates a functional block diagram of an information handling system, illustrated generally at 500, employing reduced resources to data using limited resources according to one aspect of the disclosure. The information handling system 500 includes resources of the information handling system 400 illustrated in FIG. 4. Additionally, portions of the information handling system 500 can be enabled to enable applications to output data and receive inputs using limited resources of the information handling system 500. For example, FIG. 5 illustrates several components having “dashed” lines, such as the display 514. As illustrated in FIG. 5, a dashed line indicates an activated or enabled component. Similarly, a component having a “solid” line such as the processor 502, indicates a deactivated or disabled device or component. As such, the dashed lines and solid lines are provided only to illustrate in FIG. 5 components that are enabled (available resources) or disabled (non-available resources) and should not be interpreted in any way to further limit the functionality or capability of any components, devices, etc. of the information handling system 500.

During operation of information handling system 500, resources can be initiated one or more ways. For example, a user can select the BLT access button 556, and the SIO integrated flash 548 can initiate enabling resources to enable a BLT operating state. In one form, a BLT operating state can be realized by enabling the keyboard 558, the touchpad KSI/KSO module 560, the SIO integrated flash 548, the MUX 568, the biometric input module 570, the three (3) way MUX 594, the BLT module 590, the MiniCard WWAN module 588, the second display 592, the DAI module 528, the audio bypass module 530, the speaker and amplifier 532, the power/charge system 599, the video MUX 512, the display 514, the inverter and ALS module 516, associated interconnect buses, or any combination thereof. Other modules can also be activated as needed or desired.

In the example illustrated in FIG. 5, various other devices or components of the information handling system 500 that are not to be used to output a BLT operating state can remain deactivated, disabled, or placed within a reduced power operating state. For example, the processor 502 can be placed in a reduced power state, or even in an ‘off’ state, wherein the processor may not be able to process data. As such, the information handling system 500 can enable a limited amount of resource sufficient to output a BLT operating state upon detecting an event to allocate a reduced set of resources sufficient to process, output, and receive inputs without the use of the processor 502 or other various resources. In this manner, the information handling system 500 need not initialize all components of the information handling system 500 to allow a user to access the BLT operating state of the information handling system 500.

For example, in one embodiment the information handling system 500 can be provided in a sleep or reduce power operating state capable of receiving wireless communication signals using a wireless module, such as the MiniCard WWAN 588, the BT card 550, or another wireless module that can be coupled to the information handling system 500. The received wireless signal can be detected as an incoming signal configured to be received by a smart phone device, Blackberry device, or any other type of handheld wireless device. Upon identifying the information handling system 500 can initiate various resources to respond to a detected message. For example, in one form, the information handling system 500 can enable a speaker to output a user selected or customized audio output or beep that indicates a message has been received. The beep or audio output can be customized to identify a specific sender. In one form, the information handling system 500 can include a profile that can include an output preference in response to receiving a wireless message. For example, the profile can include enabling an auto-attendant feature that allows for automatic responses to a specific type message, sender, message source, etc. The auto-attendant can respond to the message without having to initiate a keyboard, display, or various other resources. Various other types of low-power responses to messages received can also be enabled as desired.

Specific resources of the information handling system 500 can be identified in the BT card 550 and enabled to enable an operating environment to output the message. For example, upon identifying receipt of a Blackberry message, resources such as the keyboard 558, the touchpad module 560, the SIO integrated flash module 548, the video MUX 512, the first display 514, the inverter and ALS 516, the power and charge system 599 and various charge circuits sufficient to power the allocated resources, and various interconnect circuits, buses, or combinations thereof sufficient to output the received message can be enabled. Additionally, an operating system and/or application can be initialized based on the type of message received. For example, the BLT module 590 can identify the message and can initialize an operating system and/or one or more applications sufficient to output a message. For example, an application sufficient to output a message or other messaging application can be initialized, and resources sufficient to output the message can be determined and enabled. In this manner, a limited number of components or resources, and an application and/or operating system can be enabled allowing the information handling system 500 to benefit from a reduced resource operating state, thereby conserving battery or power consumption while enabling access to a specific application (e.g. a Blackberry email application).

In one form, upon identifying an operating state to enable, an operating mode of the first display 514 can be identified. For example, the first display 514 can include a memory device storing an identifier including information to determine an operating capability of the first display 514. A backlight (not illustrated) of the first display 514 can be enabled, and a separate graphics display unit or processor (not illustrated) can be used to process and output content. For example, the first display 514 can also be capable of displaying information in a reduced power state that can include activating a backlight of the first display 514. As such, initializing a limited resource operating state of the information handling system 500 can include identifying an available operating state of the first display 514 and determining an operating state sufficient to output an operating environment using limited resources of the information handling system 500.

According to another aspect, the inverter and ALS module 516 can be used to determine an operating condition of the first display 514 in a limited resource operating state. For example, the inverter and ALS module 516 can be enabled and can detect an ambient light external to the information handling system 500 and automatically adjust the intensity or display output of the first display 514 during a limited resource operating state.

According to a further aspect, the Minicard WWAN 588 can incorporate the BLT module 590 using a processor of the Minicard WWAN 588. For example, the MiniCard WWAN can include to processors (not illustrated). A first processor can be used to process wireless signals and a second processor can detect information communicated within the wireless signals. The second processor can also be configured to provide the BLT module operable to identify a type of information received within the wireless signal, and to determine resources to enable to output a specific type of information received. For example, the BLT module 590 can identify an email communication within the wireless signal and can determine an email application and resources to output the email communication without having to initialize the entire information handling system 500.

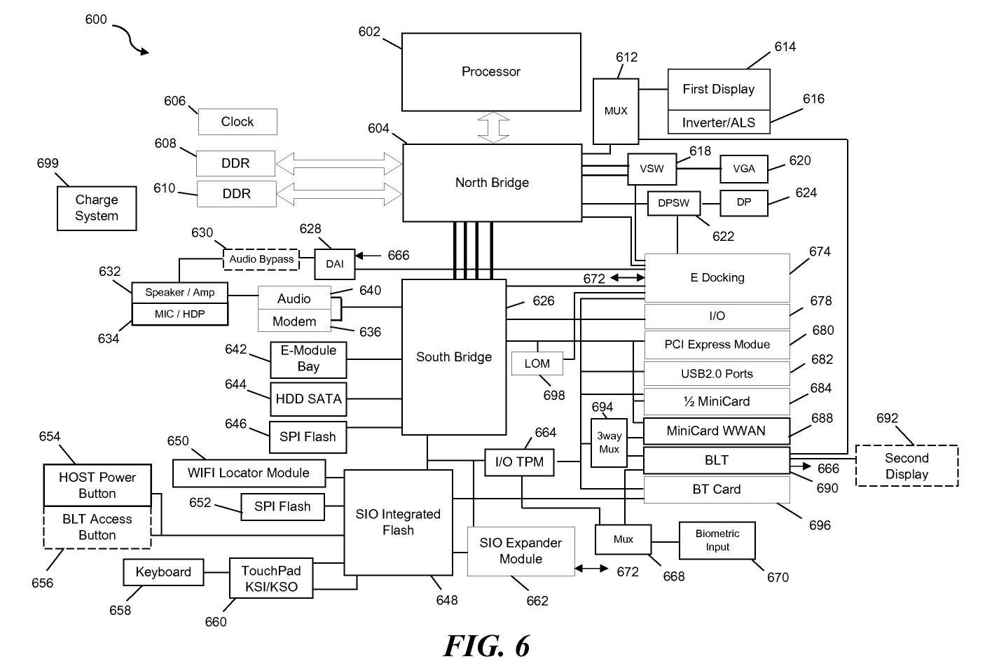

FIG. 6 illustrates a functional block diagram of an information handling system employing de-allocated resources according to one aspect of the disclosure. As illustrated, the information handling system 600 includes resources of the information handling system 400 illustrated in FIG. 4. The information handling system 600 includes a BLT access button 656, a second display 692, and an audio bypass module 630 having “dashed” lines to indicate that these modules are placed in the “off” or a “reduced power” operating state. For example, the information handling system 600 can be initialized to an operating condition that can include employing the processor 602 and associated components or devices, the north bridge 604 and associated components or devices, and the south bridge 626 and associated components or devices. As such the devices or components not activated, as indicated by the dashed lines include the audio bypass 630, the BLT access button 656, and the second display 692. For example, the audio bypass 630, the BLT access button 656, and the second display 692, can be used to access an application that can be provided with an operating system employing the processor 602. As such, the operating system can access an application sufficient to output a message and as such the BLT access button, audio bypass 630, and second display 692 need not be used to output messages received in a reduced operating state. In an exemplary form, the processor 602 can be used to enable, disable, or maintain use of the BLT module 690 and various other components. For example, when a user power's down the information handling system 600, the BLT module 690 and various other components sufficient to receive messages in a low power state can be enabled.

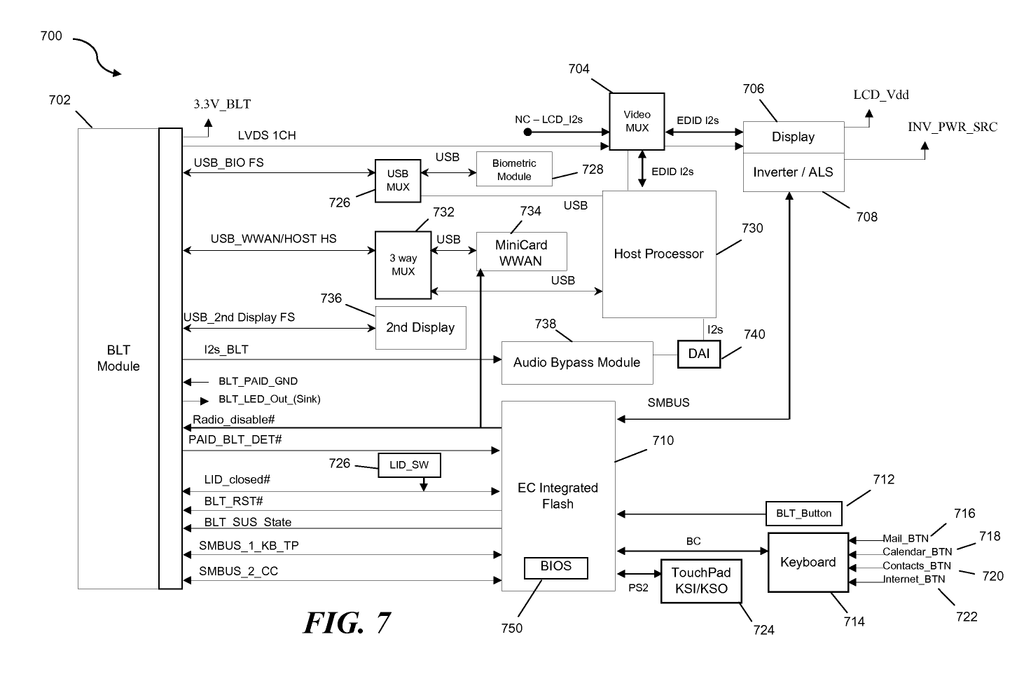

FIG. 7 illustrates a functional block diagram of an information handling system, illustrated generally at 700, configured to employ resource allocation module 702 operable to allocate limited resources of the information handling system 700 according to one aspect of the disclosure. The resource allocation module 702 can be coupled to a multiplexer 704 operable to multiplex a single channel low voltage display signal (LVDS 1 CH) and a NC_LCD_I2S signal. In one form, the EC integrated flash 710 can include a BIOS 750 operable to be used to initiate various resources of the information handling system 700. In another embodiment, the NC_LCD_I2S signal can be coupled directly to the BLT module 702 and can be selectively enabled by the BLT module 702. The video MUX 704 couples the multiplexed signal to a display 706 powered by a display power source (LCD_Vdd). The display 706 includes an inverter and ALS module 708 power by an inverter power source (INV_PWR_SRC).

The inverter and ALS module 708 can be coupled to an EC integrated flash module 710 via an SMBUS. The EC integrated flash module 710 can also be coupled to a BLT power button 712 operable to initiate a BLT operating mode. The EC integrated flash module 710 can also be coupled to a keyboard 714 that can include a qwerty keyboard having a mail button 716, a calendar button 718, a contacts button 720, and an Internet access button 722. The keyboard 714 can also include various other types of function keys as needed or desired.

The EC integrated flash module 710 can also be coupled to a touchpad 724 that enables use of a pointer or pointing device that can be displayed on the display 706. The EC Integrated flash module can also be coupled to a lid switch (LID_SW) input signal 726 operable to indicate when a lid or display of a laptop or other type of mobile information handling system may be opened or closed. Additional signals can also be input, output, or combinations thereof, between the BT module 702 and the EC integrated flash module 710, including, but not limited to, a radio disable signal (Radio_disable #), a paid BLT detection signal (PAID_BLT_DET#), a BLT reset signal (BLT_RST#), a BLT sustain state signal (BLT_SUS_State), a SMBUS Keyboard enable signal (SMBUS_{—}1_KB_TP), and an SMBUS 2 CC signal (SMBUS_{—}2_CC).

The information handling system 700 can also include a USB MUX 726 coupled to a biometric module 728 operable to input biometrics of a user. The USB MUX 726 can further be coupled to a host processor 730 of the information handling system 700. The BTS module 702 can further couple a WWAN access signal (USB_WWAN/HOST HS) to a three (3) way MUX 732 configured to be coupled to a MiniCard WWAN 734 and the host processor 730 using a USB enabled bus. The BLT module 702 can also couple a second display signal (USB_second display signal) to a second display 736. The BLT module 702 can also couple an audio bypass signal (I2s_BLT) to an audio bypass module 738 using an I²S bus and to a DAI module 740 via an I²S bus. The DAI module 740 can further be coupled to the host processor 730 via the I²S bus. Additionally, the interface for 702 (e.g. 702a) can include additional pins or coupling elements that can be used to expand the functionality of 702.

Note that not all of the activities described above in the general description or the examples are required, that a portion of a specific activity may not be required, and that one or more further activities may be performed in addition to those described. Still further, the order in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system comprising:
an event detection module operable to detect a user initiated event and a non-user initiated event;
a resource allocation module coupled to the event detection module, the resource allocation module operable to map a first detected event to a first operating state of a first processing system;
a second processing system responsive to the resource allocation module and operable to access a shared resource of the first processing system; and
wherein the resource allocation module is configured to initiate an outputting of information intended to be output by the second processing system using a shared resource of the first processing system.

2. The information handling system of claim 1, further comprising:
a first resource profile accessible by the resource allocation module, wherein the first resource profile is operable to identify a first set of resources of the first processing system to be used by the second processing system;
wherein the resource allocation module is further configured to determine an output format to output the information; and
wherein the second processing system is further configured to format the information to output using the first set of resources of the first processing system.

3. The information handling system of claim 2, further comprising:
a communication module of the first processing system operable to communicate messages; and
wherein the communication module includes a second processor accessible to the second processing system.

4. The information handling system of claim 3, further comprising:
wherein the second processor is configured to employ the event detection module operable to detect a messaging event; and
wherein the resource allocation module is configured to:
determine a first set of resources the first processing system operable to output a message in response to the detected messaging event;
determine a second set of resources of the second processing system to process the message; and
enable access to the first set of resources;
enable access to the second set of resources; and
process the detected message event using the first set of resources and the second set of resources to output the message via the first processing system.

5. The information handling system of claim 4, further comprising:
a BIOS accessible to the first processing system, the BIOS operable to be used to initiate use of the first set of resources; and
a BIOS accessible to the second processing system to be used to initiate use of the second set of resources.

6. The information handling system of claim 4, further comprising:
wherein the second set of resources includes a low resolution video translation module operable to determine a display resolution value of a display of the first processing system; and
wherein the low resolution video translator translation module is further operable to format the information to display within the display.

7. The information handling system of claim 1, further comprising a display including a memory storing a display resolution reference accessible to the first processing system and the second processing system.

8. The information handling system of claim 1, wherein the resource allocation module is configured to initiate enabling the first processing system resources and the second processing system resources.

9. The information handling system of claim 1, further comprising:
a first power system responsive to a first power profile operable to initiate a powering of the shared resource of the first processing system; and
a second power system responsive to the first power profile, the second power system operable to initiate a powering of a second processing system resource.

10. The information handling system of claim 1, further comprising:
wherein the second processing system further includes a host processor operable to access a BIOS of the first information handling system; and
wherein the host processor is stored within a communication module of the first processing system.

11. The information handling system of claim 1, further comprising:
wherein the second processing system is operable to initiate activation a messaging input resource and a messaging output resource of the first processing system in response to the detected event; and
wherein the first processing system is operable to enable a messaging operating environment accessible by the second processing system.

12. A method of enabling resources within an information handling system, the method comprising:
detecting an event operable to initiate access to a first set of resources of a first processing system;
identifying a first profile of the first processing system, the first profile including a plurality of resource allocation entries of the first processing system accessible to a second processing system;
enabling the first set of resources of the first processing system using the plurality of resource allocation entries; and
accessing the first set of resources using the second processing system.

13. The method of claim 12, further comprising:
receiving a message using a communication module of the first processing system;
determining the received message is intended to be output using the second processing system;
detecting an availability of the first set of resources to output the received message; and
accessing the first set of resources to output the received message.

14. The method of claim 13, further comprising:
accessing a BIOS of the first processing system to determine the first set of resources;
initiating use of the first set of resources including a display, wherein the display includes a display resolution value stored within a memory of the display;
enabling a second set of resources of the second processing system;
formatting the received message using the second set of resources and the first display resolution value;
outputting the formatted message to the display using the display and the display resolution entry.

15. The method of claim 12, further comprising:
detecting a first message type of a first message received by a communication module of the first processing system;
detecting the first message type is intended to be output using the second processing system; and
enabling resources of the first processing system and the second processing system to output the first message.

16. The method of claim 12, further comprising:
detecting a non-user activated event using an event detection module;
detecting whether the non-user activated event should initiate activation of the second processing system;
detecting whether the non-user activated event should initiate access to the first set of resources of the first processing system;
initiating activation of the second processing system in response to detecting the non-user activated event; and
accessing to the first set of resources in response to detecting the non-user activated event.

17. The method of claim 16, further comprising:
receiving a message using a communication module of the first processing system;
processing the received message to determine resources to output the received message;
determining available resources of the first set of resources of the first processing system;
initiating access to the available resources of the first processing system to output the received message via the first processing system; and
initiating access to the available resources of the first processing system to enable a response to the received message.

18. An information handling system comprising:
a first processing system including:
a first host processor operable to process information using a first set of available resources, wherein the first set of available resources includes:
a shared display resource including a memory device storing a display resolution value; and
a shared input device resource configured to receive inputs via a shared operating environment and a non-shared operating environment;
a second processing system including:
a second host processor operable to process information to output via the first processing system; and
a video translation module operable to access the display resolution value to format the information to output using the shared display;
an event detection module configured to detect user activated events and non-user activated events, the event detection module further configured to initiate access to the first processing system using a portion of the second processing system; and
a resource allocation module operable to determine available resources of the first processing system and the second processing system.

19. The information handling system of claim 18, further comprising a resource profile stored within a memory of the second processing system, the resource profile operable to be used to identify resources of the second processing system to use upon detecting a message received via a communication resource of the first processing system.

20. The information handling system of claim 19, further comprising a the second processor operable to:
detect a first message type of a received message via a communication module of the first processing system;
determine a messaging application to output the first message type;
determine a messaging resource profile to enable messaging resources of the first processing system and the second processing system;
initiate enabling the messaging resources of the first processing system and the second processing system; and
initiate outputting the received message using the messaging application and the messaging resources.
